(19) United States
(12) Patent Application Publication
(10) Pub. No.: US 2004/0228031 A1
(43) Pub. Date: Nov. 18, 2004

(54) Disk drive and magnetic head for perpendicular magnetic recording

(75) Inventor: Akihiko Takeo, Kunitachi-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/769,477

(22) Filed: Jan. 29, 2004

(30) Foreign Application Priority Data
Jan. 31, 2003 (JP) 2003-023875

(51) Int. Cl. G11B 5/127

(52) U.S. Cl. 360/125

(57) ABSTRACT

A magnetic head is operable for recording in a perpendicular magnetic recording manner and has a recording pole portion which has a soft magnetic film and which generates a recording magnetic flux in a vertical direction of the perpendicular magnetic recording medium and in which the recording pole portion includes a hard magnetic film to steadily apply a static field and an exchange-coupling field having the same polarity to the soft magnetic film of the recording pole portion in a direction of a track width. The recording pole portion may also have a non-magnetic layer inserted between a soft magnetic film and a hard magnetic film.

### CROSS-REFERENCE TO RELATED APPLICATIONS

This application is based upon and claims the benefit of priority from the prior Japanese Patent Application No. 2003-023875, filed Jan. 31, 2003, the entire contents of which are incorporated herein by reference.

### BACKGROUND OF THE INVENTION

1. Field of the Invention

The present invention generally relates to a disk drive using a perpendicular magnetic recording method and, more particularly, to a magnetic head using the perpendicular magnetic recording method.

2. Description of the Related Art

In recent years, a perpendicular magnetic recording method has received a great deal of attention in the field of hard disk drives. Generally, a disk drive to which the perpendicular magnetic recording method is applied uses a single pole type head as a write head and a double-layered perpendicular recording medium as a disk medium. A double-layered perpendicular recording medium is a disk medium having a soft magnetic layer formed between a substrate and a recording magnetic layer near the surface.

In perpendicular magnetic recording, a vertical magnetic field generated from the recording pole of a single pole type head is almost wholly applied to the recording layer of a disk medium. By this vertical magnetic field, a vertical magnetic flux generated in the recording layer forms a magnetic path through the soft magnetic layer.

In such a perpendicular magnetic recording method, the magnetic domain of the recording pole portion of the single pole type head becomes unstable in a non-recording operation. If even a small residual magnetization component is present, the magnetic field generated from the recording pole portion is applied to the disk medium. For this reason, information that is already magnetically recorded on the disk medium may be erased or changed. A phenomenon has actually been confirmed in which after a recording current to a write head is stopped, information temporarily recorded on the disk medium is erased by a field leakage from a single pole type head due to residual magnetization.

In addition, when the data track width on the disk medium is decreased to increase the recording density, the distal end of the recording pole portion of the write head must have a needle-like shape. With such a recording pole portion structure, there is a high probability that the residual magnetization component toward the disk medium remains higher then than non-needle-like structures in the non-recording operation.

Prior-art techniques have been proposed to suppress noise generated in the non-recording operation due to the unstable magnetic domain of a write head used in a disk drive using a longitudinal magnetic recording method.

In the first prior-art technique, magnetic domain stability of a recording pole portion is ensured using a write head having a multilayered structure of a soft magnetic layer and hard magnetic film (e.g., Jpn. Pat. Appln. KOKOKU Publication No. 5-83965). The second prior-art technique is related to a write head having a two-layered pole structure formed by bonding soft magnetic films having different characteristics (e.g., U.S. Pat. No. 5,132,859).

In the field of disk drives using the longitudinal magnetic recording method, a plurality of prior-art techniques for ensuring magnetic domain stability of a write head in the non-recording operation has been proposed. These prior-art techniques can suppress the occurrence of unstable situations in which information magnetically recorded on a disk medium is erased or changed in the non-recording operation.

However, all the above prior-art techniques are effective for only disk drives using the longitudinal magnetic recording method but not for disk drives using the perpendicular magnetic recording method with a single pole type head. The reasons will be described below in detail.

In a disk drive using the longitudinal magnetic recording method, a ring- or thin-film-shaped inductive head is used as a write head. If such a write head has magnetic domain instability, noise is recoded on the disk medium at an instant when the magnetic domain varies. However, the residual magnetization component itself due to the unstable magnetic domain is small. For this reason, a magnetic flux generated by residual magnetization normally flows to only the gap between the two thin film poles of the write head. Hence, there is only a small probability that a strong magnetic flux will flow to the disk medium surface and erases recorded information.

On the contrary, in the disk drive using the perpendicular magnetic recording method, if even a small residual magnetization component is generated due to the instable magnetic domain of the write head, a strong magnetic flux flows to the disk medium. This strong flux flow since a magnetic coupling occurs between the recording pole having the residual magnetization component and the soft magnetic film of the two-layered disk medium, and thus a strong vertical magnetic field acts on the recording layer of the disk medium. Hence, the residual magnetization component readily erases recorded information on the disk medium. Especially, in the disk drive using the perpendicular magnetic recording method, if not only user data recorded on the disk medium but also servo data for which rewrite operation is inhibited is erased, the drive system itself may be fatally damaged.

In addition, in the disk drive using the longitudinal magnetic recording, the write head executes magnetic recording at the recording gap portion. For this reason, the larger the volume of the recording pole portion becomes, the higher the magnetic recording efficiency becomes.

On the contrary, in the disk drive using the perpendicular magnetic recording method, a recording magnetic flux is generated between the surface of the recording pole, which opposes the disk medium, and the soft magnetic film of the disk medium. Hence, to increase the recording density, the area of the opposing surface of the recording pole must be decreased.

In short, when the prior-art head structures that presume the longitudinal magnetic recording method are applied to the disk drive using the perpendicular magnetic recording method, the magnetic domain stabilizing effect is small. It is therefore difficult to effectively suppress the residual magnetization component. Especially, in the recording pole structure of the second prior-art technique, the thickness of two soft magnetic films should be increased to improve the magnetic domain stabilizing effect. However, this is undesirable for a write head using the perpendicular magnetic recording method because it extends the recording pole portion.

### BRIEF SUMMARY OF THE INVENTION

In accordance with one embodiment of the present invention, there is provided a disk drive using a magnetic head which implements stable recording operation in a perpendicular magnetic recording method.

The disk drive comprises:

a perpendicular magnetic recording medium; and

a magnetic head using a perpendicular magnetic recording method and having a recording pole portion which generates a recording magnetic flux in a vertical direction of the perpendicular magnetic recording medium and in which a hard magnetic material to steadily apply a static field to a soft magnetic film of the recording pole portion in a direction of track width is added.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A and 1B show views showing the structure of a recording pole portion included in a magnetic head according to the first embodiment of the present invention;

FIG. 2 is a view for explaining magnetic recording operation of a perpendicular magnetic recording method according to the first embodiment;

FIGS. 3A to 3C show perspective views showing the structure of a disk drive using the perpendicular magnetic recording method according to the first embodiment;

FIG. 4 is a graph showing measurement examples of head positioning operation so as to explain the effect of the first embodiment;

FIG. 5 is a graph showing a measurement example related to the thickness of a non-magnetic layer so as to explain the effect of the first embodiment;

FIG. 6 is a view showing the structure of a recording pole portion according to the second embodiment;

FIG. 7 is a graph showing measurement results corresponding to the presence/absence of a recess related to the effect of the second embodiment;

FIGS. 8 and 9 are graphs showing measurement results corresponding to changes in recess amount related to the effect of the second embodiment;

FIGS. 10A and 10B show views showing the structure of a recording pole portion according to the third embodiment;

FIG. 11 is a view showing the structure of a recording pole portion according to the fourth embodiment;

FIG. 12 is a view related to a modification to the fourth embodiment;

FIG. 13 is a graph showing measurement examples of head positioning operation so as to explain the effect of the fourth embodiment;

FIG. 14 is a view showing the structure of a recording pole portion according to the fifth embodiment;

FIGS. 15A and 15B show views showing the structure of a recording pole portion according to the sixth embodiment; and

FIGS. 16 and 17 are tables showing sample specifications so as to explain the effects of the embodiments.

### DETAILED DESCRIPTION OF THE INVENTION

The embodiments of the present invention will be described below with reference to the accompanying drawing.

(First Embodiment)

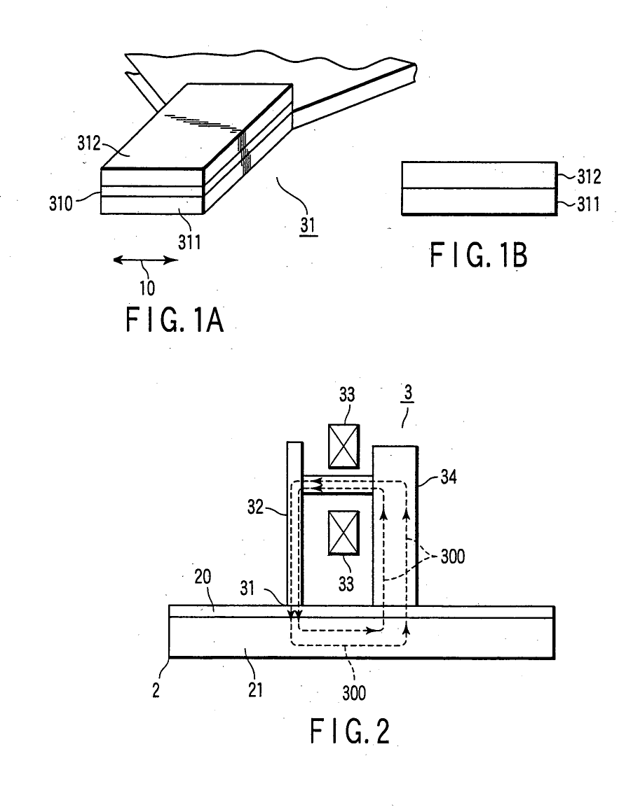

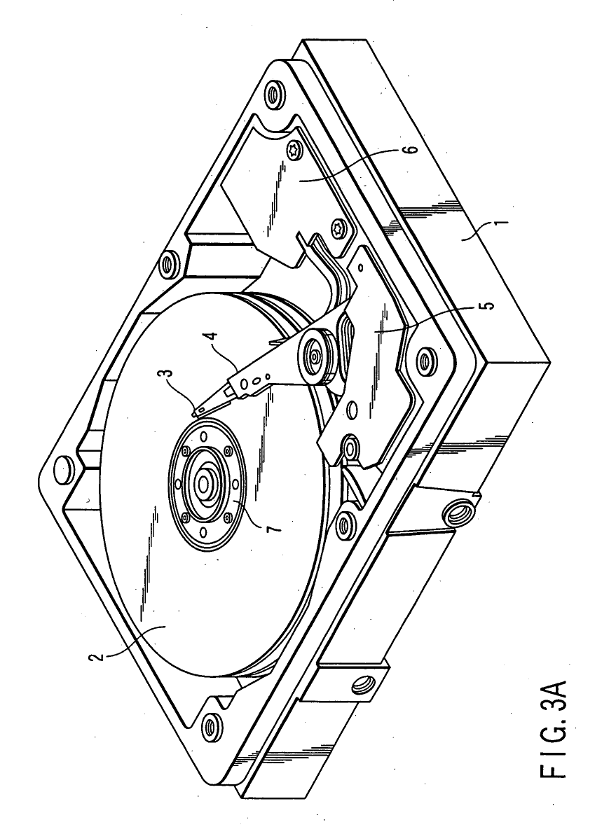

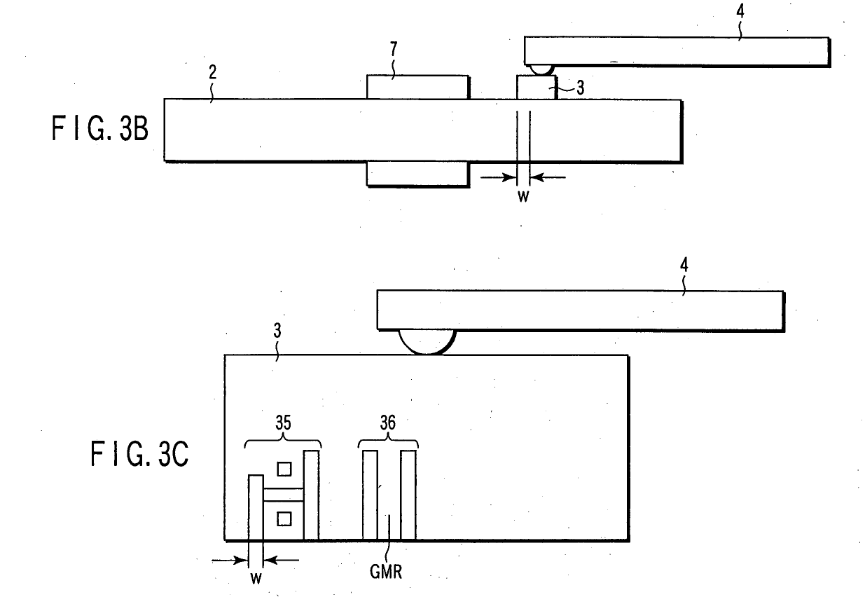

FIG. 1A is a view showing the structure of a recording pole portion included in a magnetic head (to be simply referred to as a head hereinafter) using a perpendicular magnetic recording method according to a first embodiment of the invention. FIG. 2 is a view for explaining the magnetic recording operation of the perpendicular magnetic recording method according to the first embodiment. FIGS. 3A to 3C are perspective views showing the structure of a disk drive using the perpendicular magnetic recording method according to the first embodiment.

(Structure of Disk Drive)

As shown in FIG. 3A, the disk drive using the perpendicular magnetic recording method comprises, in a housing 1, a disk medium 2, a head 3, an actuator main body (suspension and arm) 4 having the head 3, a voice coil motor (VCM) 5, and a circuit board 6.

The disk medium 2 is attached to a spindle motor 7 and rotated. The head 3 is formed by integrating a write head having a single pole structure according to this embodiment with a read head formed from a GMR (Giant MagnetoResistive) element. The VCM 5 serves as a motor that drives the actuator. The circuit board 6 has a head amplifier IC which transmits a read/write signal to the head 3. Note that a control circuit board having a drive control circuit is mounted on the lower surface of the housing 1.

As shown in FIG. 2, the disk medium 2 is a two-layered perpendicular recording medium having a perpendicular magnetic recording layer 20 and a soft magnetic layer 21, which are formed on a glass or aluminum substrate (not shown). The recording operation of the perpendicular magnetic recording method using the write head of the first embodiment and disk medium 2 of this embodiment will be described below with reference to FIG. 2.

The head 3, shown in FIG. 3B comprises a write head 35 and a read head 36 as shown in FIG. 3C. According to this embodiment, the write head 35 has a single pole structure. The write head 35 has a recording pole portion 31, a recording yoke portion 32 which concentrates a magnetic flux 300 to the recording pole portion 31, an exciting coil 33 which supplies a recording current to excite the magnetic flux 300, and a return yoke portion 34 that forms a magnetic path including the soft magnetic layer 21.

In the recording operation, when a write current flows to the exciting coil 33, a magnetic flux generated by the current is concentrated at the recording pole portion 31 by the recording yoke portion 32. A large recording magnetic field is generated between the recording pole portion 31 and the opposing soft magnetic layer 21. By this recording magnetic field, information is magnetically recorded on the recording layer 20 of the disk medium 2 in the vertical direction.

The magnetic flux 300 that has entered the soft magnetic layer 21 of the disk medium 2 passes through the return yoke portion 34 of the write head 35 to form a closed magnetic path returning to the recording yoke portion 32. The head 3 according to this embodiment constitutes a composite type read/write head that combines the above write head having the single pole structure and a read head having a shielded GMR element as illustrated in FIG. 3C.

(Structure and Function of Recording Pole Portion 31)

As shown in FIG. 1A, the recording pole portion 31 of this embodiment has a multilayered structure especially at its distal end portion (the portion that opposes the surface of the disk medium 2), in which a soft magnetic thin film 311 having a low coercive force and a hard magnetic thin film 312 having a high coercive force of at least 200×(¼π)×10³ A/m are formed on both sides of a non-magnetic layer 310. Parts except the distal end portion may be formed from a soft magnetic thin film having a high saturation magnetic flux density. An outer surface of hard magnetic film 312 is labeled as surface 312a in FIGS. 1A, 2 and 3C to assist in orienting the various views. The track width direction is shown by arrow 10 in FIG. 1A and corresponds to the width “w” shown in FIGS. 3B and 3C.

The non-magnetic layer 310 is made of a non-magnetic material such as carbon, Cu, Ti, or SiO₂. The soft magnetic film 311 can be made of a material such as CoFeNi or CoFe or a material such as CoFeN, NbFeNi, FeTaZr, FeTaN, or CoPt. The hard magnetic thin 312 is made of a material such as CoCr.

An alternates embodiment of FIG. 1A, shown in FIG. 1B, has a structure which includes the hard magnetic thin film 312 and the soft magnetic file 311 but does not include the non-magnetic layer 310. In such embodiment, an exchange-coupling field from the hard magnetic film 312 acts on the soft magnetic film 311. In a non-recording operation, this exchange-coupling field acts as a trigger magnetic field that controls the residual magnetization component of the soft magnetic film 311. The direction of the exchange-coupling field serving as a trigger magnetic field is the same as the magnetization direction of the hard magnetic film 312 (the direction of the track width on the disk medium 2). That is, the hard magnetic film 312 is magnetized in the direction of the track width.

In the information recording operation, a recording magnetic field much larger than the exchange-coupling field is excited by the exciting coil 33. For this reason, the magnetization of the soft magnetic film 311 goes toward the disk medium 2 (i.e., perpendicular to the surface of the disk medium 2) to generate a recording magnetic field corresponding to the polarity of the recording current on the disk medium.

As described above, in the non-recording operation, the exchange-coupling field from the hard magnetic film 312 acts in the direction of track width, i.e., the same direction as the magnetization direction of the film 312. At this time, a static field is generated from the track width end face of the hard magnetic film 312. In the structure having no non-magnetic layer 310, the static field directly acts on the soft magnetic film 311 adjacent to the hard magnetic film 312. The application direction is just opposite to the direction of exchange-coupling field. More specifically, the exchange-coupling field and static field coupling affect the magnetization of the soft magnetic film 311 in reverse directions. In addition, the larger the volume of the hard magnetic film 312 becomes, and the smaller the track width becomes, the stronger the function of the static field.

In this structure, the magnetization direction of the soft magnetic film 311 may change unstably depending on its shape so that the magnetization direction is along the direction of exchange-coupling field or static field coupling from the hard magnetic film 312. In addition, a small field leakage (the remaining residual magnetization component of the soft magnetic film 311) from the write head, which remains after the recording operation, may affect recorded information on the disk medium 2 and erase the information.

In the first embodiment wherein the non-magnetic layer 310 is inserted between the soft magnetic film 311 and the hard magnetic film 312, the exchange-coupling field that acts between the films 311 and 312 is suppressed. In other words, any complex magnetic field function by exchange-coupling and static field coupling from the hard magnetic film 312 is avoided. Accordingly, only the static field coupling from the track width end face is applied as a trigger magnetic field from the hard magnetic film 312 to the soft magnetic film 311. Hence, the magnetization of the soft magnetic film 311 is readily directed to a predetermined direction, i.e., the track width direction (an arrow 10 in FIG. 1A) and is stabilized.

That is, in the structure of the recording pole portion 31 according to the first embodiment, in the non-recording operation, only the magnetic field function by the static field coupling from the hard magnetic film 312 acts on the soft magnetic film 311, so the residual magnetization component of the soft magnetic film 311 can stably be controlled. Hence, any adverse effect that erases recorded information from the disk medium 2 due to the residual magnetization component of the soft magnetic film 311 can be suppressed.

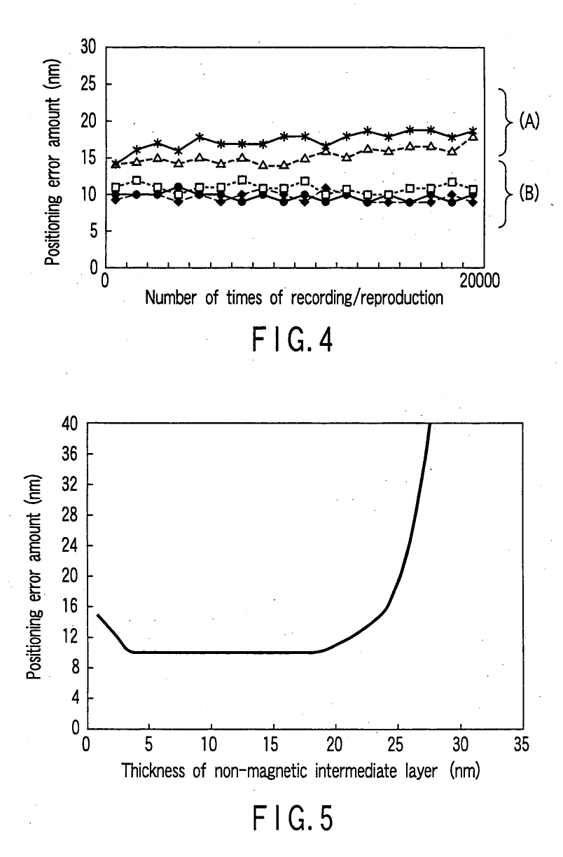

FIGS. 4 and 5 show measurement examples that represent the effect of this first embodiment.

FIG. 4 shows, as the effect of this first embodiment, measurement results of positioning error amounts in head positioning operations with respect to the number of times of recording/reproduction (20,000 times). In the disk drive, servo information recorded on the disk medium 2 in advance is read by the read head 36, thereby executing head positioning control (actual drive control of the actuator). In the read operation of reading the servo information, no recording operation by the write head 35 is executed. Hence, even when the head 3 passes on a servo sector where the servo information is recorded, the servo information is not affected. However, as described above, when an unstable residual magnetization component remains at the distal end portion of the recording pole portion 31 of the write head, the servo information recorded in the servo sector is erased or changed with a high probability when the head 3 passes on the servo sector. The probability of this phenomenon increases as the size of the distal end portion of the recording pole portion 31 decreases, as is confirmed by the experimental results.

FIG. 4 shows a comparison between a measurement result (B) for the disk drive using the head 3 having the recording pole portion 31 according to the first embodiment and a measurement result (A) for a disk drive using a head whose recording pole portion has no non-magnetic layer 310.

The specifications of the recording pole portions corresponding to the measurement results A and B correspond to samples d1, e1, and f1 of samples shown in FIG. 16. In the recording pole portion 31 corresponding to the measurement result (B), the non-magnetic layer 310 having a thickness of 10 nm is inserted between the soft magnetic film 311 and the hard magnetic film 312.

As is apparent from the measurement result (B) shown in FIG. 4, when the recording pole portion 31 according to the first embodiment wherein the non-magnetic layer 310 is used, the head positioning error amounts are smaller in all samples than those of the measurement result (A). In addition, the measurement result (B) indicates stability with respect to the number of times of recording/reproduction. When the servo signal amplitude after 10,000 recording/reproduction tests was inspected for each sample using the recording pole portion having no non-magnetic layer 310, an amplitude variation of 12% per revolution of the disk medium was observed. To the contrary, in each sample using the recording pole portion 31 according to the first embodiment, an amplitude variation of only 5% or less per revolution of the disk medium was observed.

FIG. 5 shows, for, e.g., the sample f1, the head positioning error amounts in disk drives that use heads in which the non-magnetic layers 310 of the recording pole portions 31 have various thicknesses.

As is apparent from FIG. 5, most stable positioning operation is obtained when the non-magnetic layer 310 is 3 to 20 nm thick. The reason for this is believed to be because if the non-magnetic layer 310 is too thick, the static magnetic coupling force between the hard magnetic film 312 and the soft magnetic film 311 weakens to deteriorate the initial effect. In addition, it is believed that the effect of the exchange-coupling force between the hard magnetic film 312 and the soft magnetic film 311 increases in a region where the thickness of the non-magnetic layer 310 is 2 nm or less.

As is apparent from the above measurement results, when the perpendicular magnetic recording head 3 having the recording pole portion 31 according to this first embodiment is used, the instability due to the residual magnetization component in the non-recording operation can be suppressed even when the recording pole portion 31 has a track width of 0.3 μm or less and a film thickness of 0.2 μm or less at its distal end portion. Hence, a reliable disk drive using the perpendicular magnetic recording method can be provided.

(Second Embodiment)

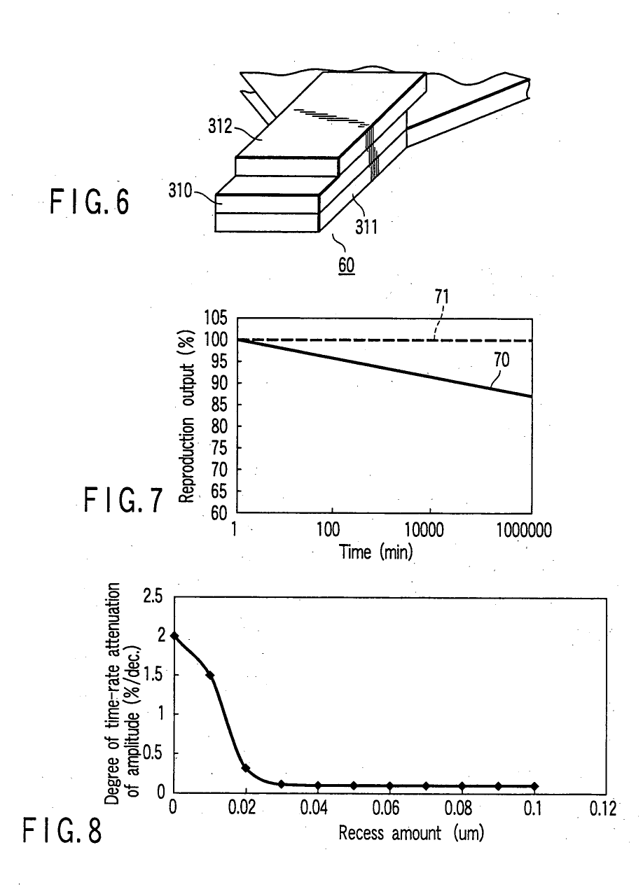

FIG. 6 is a view showing the structure of a recording pole portion 60 of a write head according to the second embodiment. The recording pole portion 60 of this embodiment is different from the above-described structure shown in FIG. 1A in that the position of a hard magnetic film 312 is recessed from the opposing surface of a disk medium 2.

FIG. 7 shows, for the specifications of the sample f1 shown in FIG. 16 described above, a measurement result 71 for a sample in which the position of the hard magnetic film 312 is recessed from the disk medium by 0.1 μm and a measurement result 70 for a sample having no recess.

To obtain the measurement results, signals are recorded on a specific track of the disk medium 2 by the write head. A time-rate change in signal amplitude of the reproduction output from the read head is inspected by continuously passing a head 3 on the track while maintaining a non-recording state. The disk drive to be measured uses a combination of two disk media: a disk (C) whose nucleation field in the lower right quadrant in an MH loop representing the magnetic characteristic of the perpendicular magnetic recording layer of a disk medium has a size of 2000×(¼π)×10³ A/m and a disk (D) whose nucleation field has a size of 0.5×1000×(¼π)×10³ A/m. In each disk, the thickness of a recording magnetic layer 20 is 20 nm, and the thickness of a soft magnetic layer 21 is 100 nm.

FIG. 7 shows measurement results for the disk drive that uses the disk (D). As is apparent from the measurement result 71 of the sample with the recess, no time-rate degradation in the reproduced signal is observed. To the contrary, in the measurement result 70 of the sample with a recess amount of 0, the reproduced signal attenuates over time.

As can be estimated from the measurement results 70 and 71 shown in FIG. 7, when the recess amount is zero, since one side of the hard magnetic film 312 is exposed near the disk medium surface, a predetermined field leakage due to the uneven magnetization of the hard magnetic film 312 is applied to the disk medium to degrade the magnetization information. However, since the hard magnetic film 312 is magnetized in the direction of the track width, the field leakage to the disk medium side is not always strong. For this reason, in the disk medium (C) having a large nucleation field, this field leakage problem is hardly present. Actually, in the disk drive using the disk medium (C), no time-rate degradation is observed in amplitude of the reproduced signal from the read head independently of the presence/absence of the recess of the hard magnetic film 312 at the distal end of the write head.

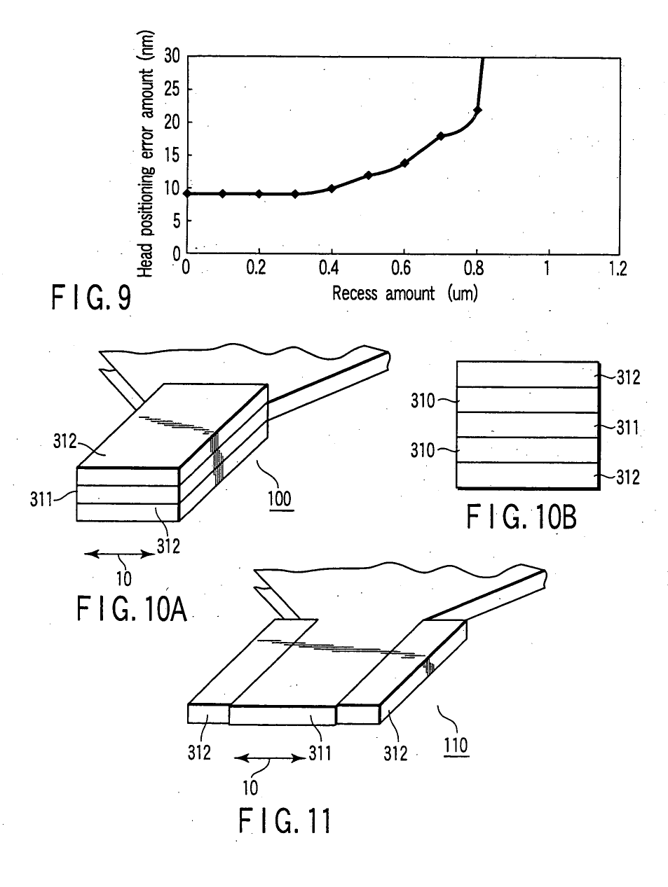

Measurement results when the recess amount is changed will be described with reference to FIGS. 8 and 9.

FIG. 8 shows a measurement result for a disk drive using the disk (C). This measurement result indicates a change in degree of amplitude degradation when the recess amount of the hard magnetic film 312 is changed. An improvement effect is observed for a recess amount of 0.02 μm or more. The larger the recess amount becomes, the less degradation in signal amplitude is observed until the amount of degradation levels off at about 0.04 μm.

FIG. 9 shows a measurement result for a disk drive using the disk (C). This measurement result is obtained by measuring the head positioning error amount on a specific track on the disk medium every time recording/reproduction is repeated on the track 10 revolutions. In this measurement result, conversely, the smaller the recess becomes, the more stable the positioning operation. When the recess amount exceeds 0.4 μm, the magnetization effect of the hard magnetic film 312 is not observed, and the positioning operation becomes unstable. This is because the larger the recess amount becomes, the smaller the field leakage from the hard magnetic film 312 to the disk medium becomes although the more difficult magnetic domain control at the distal end portion of a soft magnetic film 311 becomes. These results were commonly observed independently of the presence/absence of a non-magnetic layer 310 sandwiched between the soft magnetic film 311 and the hard magnetic film 312.

In short, in the structure according to this embodiment, the recess amount of the hard magnetic film 312 from the opposing surface of the disk medium is effective within the range of 0.02 μm to 0.4 μm. That is, any field leakage from the hard magnetic film 312 to the disk medium can be suppressed. This effect was observed especially in a combination with a disk medium with a small nucleation field.

(Third Embodiment)

FIG. 10A is a view showing the structure of a recording pole portion 100 of a write head according to a third embodiment. In the recording pole portion 100 according to this embodiment, two hard magnetic films 312 are arranged on both sides of a soft magnetic film 311 to be perpendicular to the direction of track width (arrow 10) of a disk medium 2. In other words, the recording pole portion 100 has a multilayered structure in which the hard magnetic films 312 are arranged on both sides of the direction of thickness of the soft magnetic film 311 serving as an intermediate layer.

With this structure, the magnetic domain stabilizing effect from the hard magnetic film 312 can be further increased, and the soft magnetic film 311 can be more stably magnetized. In this case, the thickness of the soft magnetic film 311 is, e.g., about 0.2 μm.

Alternatively, as shown in FIG. 10B, a non-magnetic intermediate layer may be inserted between the soft magnetic film 311 and each hard magnetic film 312. With this structure, the exchange-coupling field between the soft magnetic film 311 and each hard magnetic film 312 can be cut off, and the magnetic domain of the soft magnetic film 311 can be stabilized by the static field coupling effect.

(Fourth Embodiment)

FIG. 11 is a view showing the structure of a recording pole portion 110 according to a fourth embodiment of the invention. In the recording pole portion 110 according to this embodiment, two hard magnetic films 312 are arranged on both sides of a soft magnetic film 311 along the direction of track width (arrow 10) of a disk medium 2. Each hard magnetic film 312 is uniformly magnetized in the direction of track width in advance.

With this structure, since the exchange-coupling force and static magnetic coupling force from the hard magnetic films 312 act in the same directions, the magnetic domain of the soft magnetic film can be further stabilized.

(Modification)

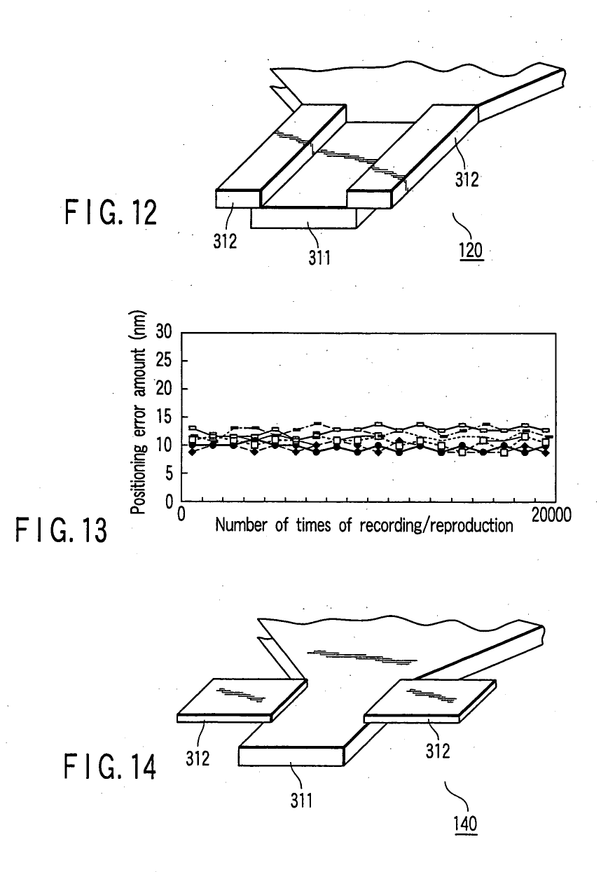

FIG. 12 is a view showing the structure of a recording pole portion 120 according to a modification to the fourth embodiment. In this modification, the two hard magnetic films 312 are arranged on the upper (shown) or lower (not shown) surface of the soft magnetic film 311 in the direction of track width. In this case, each hard magnetic film 312 and the soft magnetic film 311 may joint only at their end portions as shown in FIG. 12.

This structure can be obtained by employing such a manufacturing procedure that after the soft magnetic film 311 is formed and planarized, the hard magnetic films 312 are formed. Hence, the manufacturing process can be made simple relative to the structure shown in FIG. 11.

FIG. 13 shows measurement results for a disk drive which uses a disk medium with a 100-nm thick soft magnetic layer 21 when samples a to h shown in FIG. 17 are used as the recording pole portion 110 of the fourth embodiment. These measurement results are obtained by measuring the head positioning error amount on a specific track on the disk medium every time recording/reproduction is repeated on the track 10 revolutions. In these measurement results, the head positioning error amount was 12 nm or less, and no increase in error amount corresponding to the number of times of recording was observed in all samples.

The same measurement results as described above are obtained even in the modification shown in FIG. 12. In this structure, the thickness of the hard magnetic film 312 is 0.1 μm, and the length of the overlapping portion between the soft magnetic film 311 and the hard magnetic film 312 is 0.05 μm.

(Fifth Embodiment)

FIG. 14 is a view showing the structure of a recording pole portion 140 of a write head according to the fifth embodiment. In the recording pole portion 140 according to this embodiment, the positions of two hard magnetic film 312 are recessed from the opposing surface of a disk medium 2 with respect to a soft magnetic film 311.

Even with this structure, any field leakage from the two hard magnetic films 312 to the disk medium can be suppressed, as in the structure shown in FIG. 6 described above. As a detailed example, a time-rate change in reproduced signal amplitude was inspected while setting the thickness of the hard magnetic film 312 to 0.05 μm and changing the recess amount. As a result, any degradation in reproduced signal amplitude can be suppressed when the recess amount is 0.02 μm or more. When the recess amount is 0.3 μm or less, the stability of positioning operation can also simultaneously be controlled, a result which is expected and consistent with the results obtained in connection with the structure of FIG. 6.

(Sixth Embodiment)

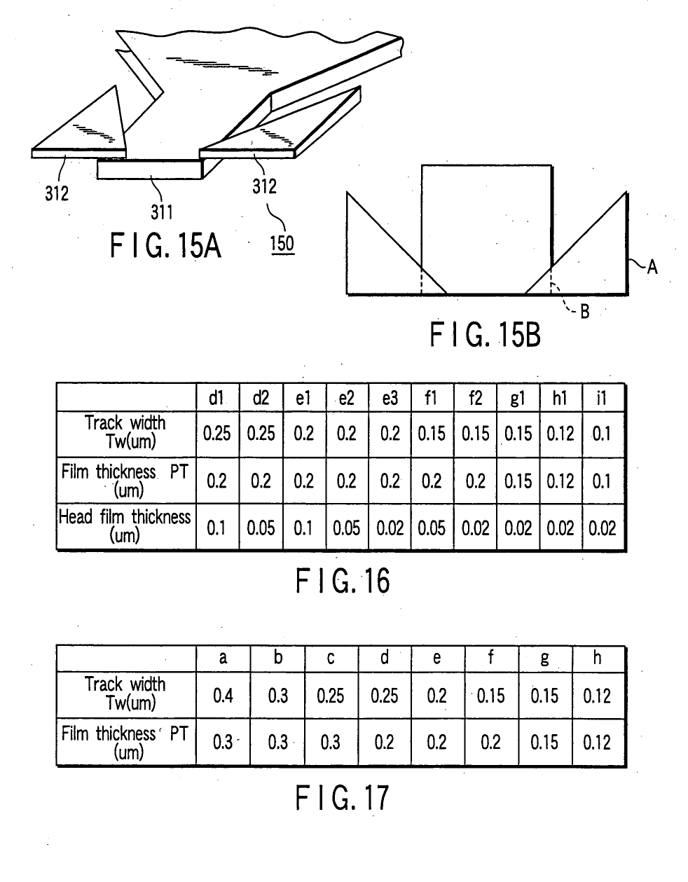

FIG. 15A is a view showing the structure of a recording pole portion 150 of a write head according to a sixth embodiment of the invention. In the recording pole portion 150 according to this embodiment, the direct joint portion between each hard magnetic film 312 and a soft magnetic film 311 is limited to the distal end portion of the opposing surface of the disk medium. More specifically, as shown in FIG. 15B, which is a top plan view of FIG. 15A, the direct joint portions, B, between the two hard magnetic films 312 and the soft magnetic film 311 are shorter than the long edge depth dimension, A, of the hard magnetic films 312 with respect to the depth direction from the opposing surface of the disk medium and are limited to the opposing surface portion side of the disk medium. With this structure, the magnetization positions by the hard magnetic films 312 are limited to the head distal end portion. Accordingly, magnetic domain control of the soft magnetic film 311 having a more complex magnetic domain structure can be implemented.

The above-described structure shown in FIG. 12 controls magnetization of the entire soft magnetic film 311. In this case, no problem is posed when the soft magnetic film 311 is made of a crystallite material such as FeAlSi or FeTaZr. However, for an amorphous material such as CoZrNb or CoFe that readily generates a predetermined magnetic wall distance and a complex magnetic wall, magnetization that stops the flow of the original magnetic domain may occur. Especially, as the three-dimensional shape of the recording pole portion becomes more complex, such a problem is presented with greater probability.

Using CoFe of the sample (h) shown in FIG. 17 as a soft magnetic material, the characteristic of the structure shown in FIG. 12 was compared with that of the structure shown in FIG. 15A. This test presumes a disk drive using the disk (C). Amplitude variations for every 1,000 recording/reproduction cycles were measured. As a result, in the head having the structure shown in FIG. 12, the standard deviation of amplitude variation was 4.8%. In the head having the structure shown in FIG. 15A, the standard deviation of amplitude variation was 0.4%.

As described above, it is effective to adjust the joint position between the hard magnetic film 312 and the soft magnetic film 311 at the head distal end portion in accordance with the application purpose. Especially, in a disk drive using a disk medium having a small nucleation field, the structure in which the position of the hard magnetic film 312 is recessed is effective. Conversely, to ensure stable recording operation independently of the soft magnetic material of the head, it is effective to limit the joint position between the hard magnetic film 312 and the soft magnetic film 311 to the distal end.

The above embodiments presume a disk drive using the perpendicular magnetic recording method. However, they can also be applied not only to a drive using a disk medium but also to a drive using a magnetic recording medium of another type such as a magnetic tape.

As has been described above in detail, according to each of the above embodiments, a disk drive using a magnetic head that implements stable recording operation in the perpendicular magnetic recording method can be provided. That is, according to each of the above embodiments, the disk drive using the perpendicular magnetic recording method has, as its characteristic feature, a magnetic head having a recording pole portion whose structure suppresses any residual magnetization component in the non-recording operation. With the disk drive using the magnetic head having the recording pole portion with the static magnetic coupling structure, the influence of leakage flux on recorded information on the disk medium can be effectively suppressed. For this reason, the problem that the recorded information may be erased or changed can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive for use with a perpendicular magnetic recording medium comprising:
(a) a magnetic head having a recording pole portion;
(b) said recording pole portion including:
(1) a soft magnetic film; and
(2) a hard magnetic film;
(c) said hard magnetic film applying a static magnetic field to said soft magnetic film in a direction of a track width of said perpendicular magnetic recording medium; and
(d) said recording pole portion generating a recording magnetic flux in a direction perpendicular to a surface of said surface of said perpendicular magnetic recording medium.

2. A disk drive for use with a perpendicular magnetic recording medium comprising:
(a) a magnetic head having a recording pole portion;
(b) said recording pole portion including:
(1) a soft magnetic film;
(2) a hard magnetic film; and
(3) a non-magnetic layer disposed between said soft magnetic film and said hard magnetic film;
(c) said hard magnetic film applying a static magnetic filed to said soft magnetic film in a direction of a track width of said perpendicular magnetic recording medium; and
(d) said recording pole portion generating a recording magnetic flux in a direction perpendicular to a surface of said surface of said perpendicular magnetic recording medium.

3. A drive according to claim 2, wherein the hard magnetic film of the magnetic head is uniformly magnetized in a direction of said track width.

4. A drive according to claim 2, wherein in the magnetic head, the hard magnetic film is arranged at a position recessed from an opposing surface of a disk medium with respect to the soft magnetic film.

5. A disk drive comprising:
a perpendicular magnetic recording medium; and
a magnetic head operable for recording in a perpendicular magnetic recording manner and having a recording pole portion which generates a recording magnetic flux in a vertical direction of the perpendicular magnetic recording medium, said recording pole portion having a multilayered structure in which hard magnetic films are arranged on both sides in a thickness direction of a soft magnetic film serving as an intermediate layer.

6. A drive according to claim 5, wherein in the magnetic head, the recording pole portion has a multilayered structure in which a non-magnetic layer and a hard magnetic film are sequentially arranged on each side in the direction of thickness of the soft magnetic film serving as the intermediate layer.

7. A disk drive comprising:
a perpendicular magnetic recording medium; and
a magnetic head operable for recording in a perpendicular magnetic recording manner and having a recording pole portion which has a soft magnetic film and which generates a recording magnetic flux in a vertical direction of the perpendicular magnetic recording medium and in which further includes a hard magnetic film to steadily apply a static field and exchange-coupling field having the same polarity to said soft magnetic film of the recording pole portion in a direction of track width.

8. A drive according to claim 5, wherein in the magnetic head, the recording pole portion has a multilayered structure in which the hard magnetic film is positioned on one side, in a direction of track width of the soft magnetic film, and another hard magnetic film is position on the other side of the soft magnetic film, said soft magnetic film serving as the intermediate layer between said one and another hard magnetic films.

9. A drive according to claim 5, wherein in the magnetic head, a multilayered structure is formed in which a first non-magnetic layer is positioned between the soft magnetic film and the hard magnetic film and a second non-magnetic film is positioned between the soft magnetic film and the other hard magnetic film.

10. A drive according to claim 8, wherein in the magnetic head, the recording pole portion has the soft magnetic film and the hard magnetic films, joined in a staggered layout.

11. A drive according to claim 5, wherein in the magnetic head, each of the hard magnetic films is arranged at a position recessed from an opposing surface of the disk medium with respect to the soft magnetic film.

12. A drive according to claim 5, wherein in the magnetic head, a direct joint portion between each of the hard magnetic films and the soft magnetic film is shorter than a depth dimension of each hard magnetic film with respect to a depth direction from an opposing surface of the disk medium and is limited to an opposing surface portion side of the disk medium.

13. A drive according to claim 1, wherein the magnetic head has a structure in which a write head including the recording pole portion and a read head including a reproduction element to read out a recorded signal from the disk medium are arranged on a single slider.

14. A magnetic head for perpendicular magnetic recording in a disk drive, comprising:
a recording pole portion having a soft magnetic film and which generates a recording magnetic flux in a vertical direction of a perpendicular magnetic recording medium; and
a hard magnetic material to steadily apply a static field to the soft magnetic film of the recording pole portion in a direction of a track width in the recording pole portion.

15. A magnetic head for perpendicular magnetic recording in a disk drive, comprising:
a recording pole portion having a soft magnetic film and a hard magnetic film and which generates a recording magnetic flux in a vertical direction of a perpendicular magnetic recording medium; and
an intermediate layer which is positioned between the soft magnetic film and the hard magnetic film to obtain a static magnetic coupling effect.

16. A head according to claim 15, wherein the recording pole portion has a multilayered structure in which a non-magnetic layer serving as the intermediate layer is positioned between the soft magnetic film and the hard magnetic film.

17. A head according to claim 15, wherein the hard magnetic film is arranged at a position recessed from an opposing surface of the perpendicular magnetic recording medium with respect to the soft magnetic film.

18. A magnetic head for perpendicular magnetic recording in a disk drive, comprising:
a recording pole portion having a soft magnetic film and which generates a recording magnetic flux in a vertical direction of a perpendicular magnetic recording medium,
wherein the recording pole portion has a multilayered structure in which hard magnetic films are arranged on both sides in a direction of thickness of the soft magnetic film serving as an intermediate layer.

19. A head according to claim 18, wherein the recording pole portion has a multilayered structure in which a non-magnetic layer and a hard magnetic film are sequentially arranged on each side in the direction of thickness of the soft magnetic film serving as the intermediate layer.

20. A magnetic head for perpendicular magnetic recording in a disk drive, comprising:
a recording pole portion having a soft magnetic film and which generates a recording magnetic flux in a vertical direction of a perpendicular magnetic recording medium; and
a hard magnetic material to steadily apply a static field and exchange-coupling field having the same polarity to the soft magnetic film of the recording pole portion in a direction of track width in the recording pole portion.

21. A head according to claim 20, wherein the recording pole portion has a multilayered structure in which hard magnetic films are arranged on both sides in a direction of track width of the soft magnetic film serving as an intermediate layer.

22. A head according to claim 20, wherein the recording pole portion has the soft magnetic film and the hard magnetic films joined in a staggered layout.

23. A head according to claim 18, wherein each of the hard magnetic films is arranged at a position recessed from an opposing surface of the perpendicular magnetic recording medium with respect to the soft magnetic film.

24. A head according to claim 18, wherein a direct joint portion between each of the hard magnetic films and the soft magnetic film is shorter than a depth dimension of each hard magnetic film with respect to a depth direction from an opposing surface of the perpendicular magnetic recording medium and is limited to an opposing surface portion side of the perpendicular magnetic recording medium.
